(19) United States
(12) Patent Application Publication
(10) Pub. No.: US 2012/0278738 A1
(43) Pub. Date: Nov. 1, 2012

(54) Interactive and Collaborative Computing Device

(75) Inventors: Ross Kruse, Salem, OR (US); Steve Stark, Portland, OR (US); Gary Elsasser, Coto De Caza, CA (US); Glenn Jystad, Dove Canyon, CA (US); Yifan Li, Diamond Bar, CA (US); Scott Morford, Dakota Dunes, SD (US); Raymond Yu, Fremont, CA (US)

(73) Assignee: INFOCUS CORPORATION, Portland, OR (US)

(21) Appl. No.: 13/456,386

(22) Filed: Apr. 26, 2012

Related U.S. Application Data
(60) Provisional application No. 61/479,292, filed on Apr. 26, 2011.

(51) Int. Cl. G06F 3/01; G06F 3/048

(52) U.S. Cl. 715/754; 715/753; 715/756

(57) ABSTRACT

Systems and methods are provided for an interactive and collaborative computing device. One example device enables users to establish a communicative link with the interactive and collaborative computing device such that each user may view and share information whether in a local or remote interactive and collaborative environment. The systems and methods described herein further provide a way for users to annotate content displayed on the interactive and collaborative computing device by providing annotative input via another computing device.

### CROSS REFERENCE TO RELATED APPLICATIONS

This application claims priority to U.S. Provisional Patent Application Ser. No. 61/479,292, filed Apr. 26, 2011 and entitled “Interactive and Collaborative Computing Device,” the entirety of which is hereby incorporated herein by reference.

### FIELD

The present disclosure relates generally to apparatus, systems and methods for an interactive and collaborative computing device.

### BACKGROUND AND SUMMARY

Projection systems are widely available as tools for displaying presentations in conference rooms, lecture halls, classrooms, etc. With the development of more sophisticated lens systems, projectors have become more versatile in terms of their placement within the room. For example, a projector with a wide angle lens system can be placed closer to the screen such that a passerby's shadow is not cast upon the screen during the presentation. While this may enhance the visual quality of the presentation from the perspective of the projector, incompatibility issues between the projector and a computer can lead to mismatched aspect ratios, image compression, absent content, and other visual impairments. Naturally, this can cause frustration for the presenter and the audience.

Solutions to enhance conference room technology have been addressed in numerous ways. For example, some conference environments are configured to wirelessly connect a personal laptop computer to an in-house projector. However, a seamless wireless connection between the personal computer and the projector can be difficult due to network connectivity issues. In other solutions, users may directly connect a personal laptop computer to a projector to display the presentation, yet access to other programs, applications and/or the internet during the presentation requires the user to exit the presentation-based software. Switching between different programs not only interrupts the flow of the presentation but also leads to inefficient task management.

The inventors have recognized the above-described issues with previous approaches to conference room technology. Accordingly, an interactive and collaborative computing device is provided to address these issues and facilitate multiple user interaction and collaboration during a conferencing session.

For example, one embodiment of an interactive and collaborative computing device includes an interaction module including a first display integral to the interactive and collaborative computing device and an input sensor, a collaboration module including a first camera, a networking module including a network interface, a control module, and a mass storage unit integral to the interactive and collaborative computing device and communicatively coupled to the collaboration module, the networking module, and the remote control module. The mass storage unit may hold instructions executable by a processor of the interactive and collaborative computing device to present a multimedia presentation to an audience via the first display, establish a communicative link with a first user computing device via the network interface, receive input from the first user computing device at the control module, upon receiving the input at the control module, alter the multimedia presentation on the first display of the interactive and collaborative computing device in accordance with the input.

In another example embodiment, a method for establishing a communicative link with an interactive and collaborative computing device including a first display and a touch input sensor includes establishing a communicative link between the interactive and collaborative computing device and a first user computing device including a second display, and presenting a presentation to the first display and the second display. Upon establishing the communicative link, the method may include detecting input by a sensor of the first user computing device to alter the presentation, sending the input to the interactive and collaborative device, controlling via a control module an alteration of the presentation based on the detected input, and displaying, on the first display and the second display, the alteration of the presentation.

In a further example embodiment, a system for an interactive and collaborative environment includes a first interactive and collaborative computing device having an integrated first display, including an interaction module, a collaboration module, a networking module, a control module, and a mass storage unit integral to the first interactive and collaborative computing device. The system may also include a first source device communicatively linked to the first interactive and collaborative computing device via a network, wherein content viewed on the first display of the first interactive and collaborative computing device is annotated via user input detected by the first source device, and wherein annotated content is implemented by the control module in real-time and provided on the first display of the first interactive and collaborative computing device and provided on a second display of the first source device.

### BRIEF DESCRIPTION OF THE FIGURES

FIG. 1 shows an embodiment of an interactive and collaborative computing environment including an interactive and collaborative computing device.

FIG. 2 schematically shows various example network connections between source devices in communication with the interactive and collaborative computing device shown in FIG. 1.

FIG. 3 shows various example functions of the interactive and collaborative computing device shown in FIG. 1.

FIG. 4 schematically shows an embodiment of a communicative link between the interactive and collaborative computing device shown in FIG. 1 and embodiments of computing devices.

FIG. 5A shows a flowchart of an embodiment of a method for communicatively linking a source device to the interactive and collaborative computing device shown in FIG. 1.

FIG. 5B shows a flowchart of an embodiment of a method for presenting and altering a presentation on the interactive and collaborative computing device shown in FIG. 1.

FIG. 6 shows an example of an embodiment of a graphical user interface (GUI) including an administrator log in for use with the interactive and collaborative computing device shown in FIG. 1.

FIG. 7 shows an example of an embodiment of a graphical user interface (GUI) including an administrator view and share folder management for use with the interactive and collaborative computing device shown in FIG. 1.

FIG. 8 shows an example of an embodiment of a graphical user interface (GUI) including an administrator device settings page for use with the interactive and collaborative computing device shown in FIG. 1.

FIG. 9 shows an example of an embodiment of a graphical user interface (GUI) including a network settings page for use with the interactive and collaborative computing device shown in FIG. 1.

FIG. 10 shows an example of an embodiment of a graphical user interface (GUI) including a WINDOWS™ administrator log in for use with the interactive and collaborative computing device shown in FIG. 1.

FIG. 11 shows an example of an embodiment of a graphical user interface (GUI) including a home screen for use with the interactive and collaborative computing device shown in FIG. 1.

FIG. 12 shows an example of an embodiment of a graphical user interface (GUI) including a bottom application pull-up element for use with the interactive and collaborative computing device shown in FIG. 1.

FIG. 13 shows an example of an embodiment of a graphical user interface (GUI) including a home screen with sidebars closed for use with the interactive and collaborative computing device shown in FIG. 1.

FIG. 14 shows an example of an embodiment of a graphical user interface (GUI) including a home page background settings page for use with the interactive and collaborative computing device shown in FIG. 1.

FIG. 15 shows an example of an embodiment of a graphical user interface (GUI) including a home screen settings page for use with the interactive and collaborative computing device shown in FIG. 1.

FIG. 16 shows an example of an embodiment of a graphical user interface (GUI) including a list of WINDOWS7™ applications for use with the interactive and collaborative computing device shown in FIG. 1.

FIG. 17 shows an example of an embodiment of a graphical user interface (GUI) including a WINDOWS7™ control panel for use with the interactive and collaborative computing device shown in FIG. 1.

FIG. 18 shows an example of an embodiment of a graphical user interface (GUI) including a calendar settings page for use with the interactive and collaborative computing device shown in FIG. 1.

FIG. 19 shows an example of an embodiment of a graphical user interface (GUI) including a PDF presentation for use with the interactive and collaborative computing device shown in FIG. 1.

FIG. 20 shows an example of an embodiment of a graphical user interface (GUI) including a POWERPOINT™ presentation for use with the interactive and collaborative computing device shown in FIG. 1.

FIG. 21 shows an example of an embodiment of a graphical user interface (GUI) including a home screen after starting a meeting for use with the interactive and collaborative computing device shown in FIG. 1.

FIG. 22 shows an example of an embodiment of a graphical user interface (GUI) including a video conferencing page for use with the interactive and collaborative computing device shown in FIG. 1.

FIG. 23 shows an example of an embodiment of a graphical user interface (GUI) including a view and share screen for use with the interactive and collaborative computing device shown in FIG. 1.

FIG. 24 shows an example of an embodiment of a graphical user interface (GUI) including a web browser for use with the interactive and collaborative computing device shown in FIG. 1.

FIG. 25 shows an example of an embodiment of a graphical user interface (GUI) including a whiteboard application for use with the interactive and collaborative computing device shown in FIG. 1.

### DETAILED DESCRIPTION

Aspects of this disclosure will now be described by example and with reference to the illustrated embodiments. Components and other elements that may be substantially the same in one or more embodiments are identified coordinately and are described with minimal repetition. It will be noted, however, that elements identified coordinately may also differ to some degree. It will be further noted that the drawings included herein are schematic and generally not drawn to scale. Rather, the various drawing scales, aspect ratios, and numbers of components shown in the figures may be purposely distorted to make certain features or relationships easier to see. Therefore, the figures are not intended to be technically precise, but are drawn to ease understanding.

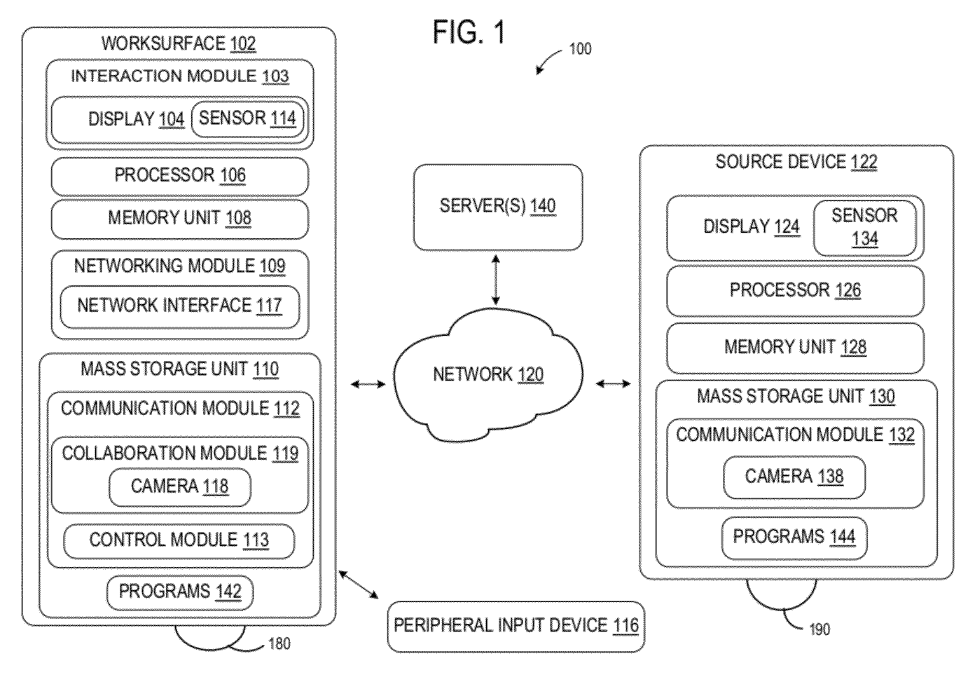

FIG. 1 schematically shows an interactive and collaborative computing environment 100 including an interactive and collaborative computing device, such as WorkSurface device 102. WorkSurface device 102 may be configured to connect users via their user computing devices such that users may connect, share information, create, and collaborate with each other. For example, WorkSurface device 102 may be used in a conference room such that members of the audience (e.g., those located in the conference room) may collaborate via their user computing devices. Further, WorkSurface device 102 may be configured such that users located remotely (e.g., those not present in the conference room) may collaborate via their user computing device.

In this way, WorkSurface device 102 may be a primary or host computing device facilitating input from one or more source and/or user computing devices (e.g., source device 122). In some embodiments, WorkSurface device 102 may include an interaction module 103, including a display 104 for displaying such input. For example, in some embodiments, interaction module 103 may facilitate user interaction with WorkSurface device 102. As described in more detail below, WorkSurface device 102 may connect users with each other whether the source device is physically located in the same conference room as WorkSurface device 102, or if the source device is located remotely (for example, if the source device is not in the conference room described in the scenario above).

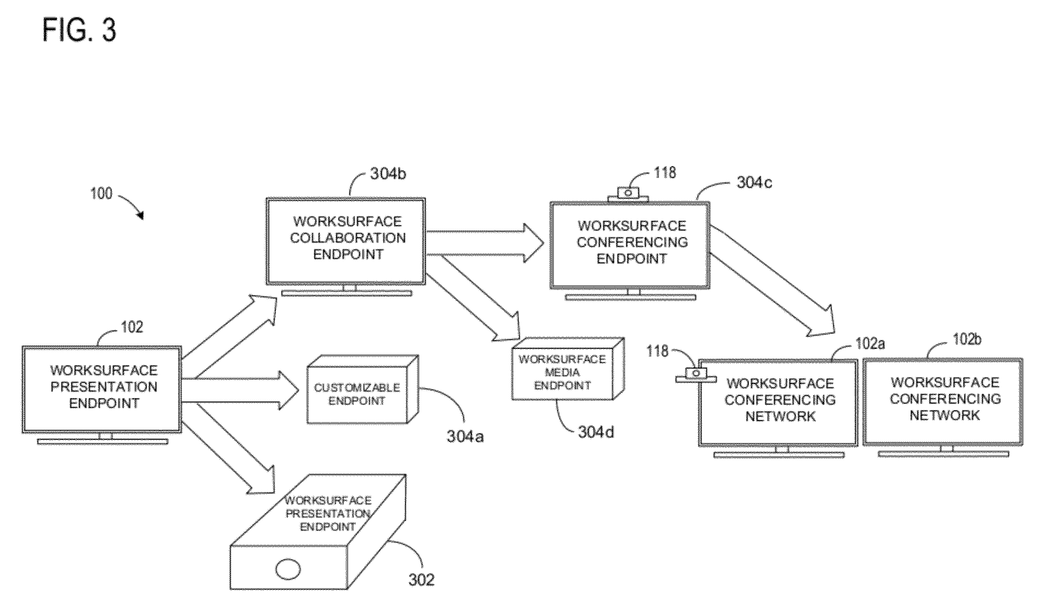

WorkSurface device 102 may be configured to display visuals and/or to project audio to an audience. For example, WorkSurface device 102 may be used to share a multimedia presentation with an audience. Further, WorkSurface device 102 may be configured such that members of the audience may contribute to the presentation. In one example, audience members may use an interactive whiteboard application to collaborate via user computing devices electronically linked with WorkSurface device 102. Such interactive features of WorkSurface device 102 will be discussed in greater detail with reference to FIG. 3 below.

WorkSurface device 102 is a computing device, and as such may include display 104, processor 106, memory unit 108, Networking module 109, and mass storage unit 110. Communication module 112, control module 113, and various programs 142, such as the interactive whiteboard application introduced above, for example, may be stored on mass storage unit 110 and may be executed by the processor 106 using memory unit 108 to cause operation of the systems and methods described herein.

In some embodiments, display 104 may be a large format display. For example, display 104 may be greater than 50 inches measured diagonally. For example, in some embodiments, a large format display may allow the WorkSurface device 102 to present a presentation to a conference room. In additional or alternative embodiments, a large format display may allow the WorkSurface device 102 to present a presentation to a large audience in any suitable location. For example, in some embodiments, a large format display may allow a large audience to directly interact with WorkSurface device 102 and/or the presentation being presented on WorkSurface device 102. However it will be appreciated that other display sizes are possible and that display 104 may have any suitable size. Display 104 may be an optical touch sensitive display and as such may include a sensor subsystem including sensor 114 for detecting and processing touch input. Sensor 114 may be configured to detect one or more touches directed toward display 104, wherein more than one touch may be detected concurrently. In an example embodiment, a sensor subsystem including sensor 114 may be operable to detect and process multiple simultaneous touch inputs. It should be appreciated that in some embodiments, the sensor subsystem may not be operable to detect and process multiple simultaneous touch inputs. Display 104 may employ any of a variety of suitable display technologies for producing a viewable image. For example, the display may include a liquid crystal display (LCD).

Sensor 114 may be any one of a variety of suitable touch sensors. For example, in one non-limiting example, sensor 114 may include an optical sensor having cameras positioned along a first edge of the display and mirrors positioned on an opposing edge of the display. Such a configuration may detect a touch on the top surface of display 104. For example, a touch may be detected from one or more fingers of a user, one or more palms of a user and/or a touch associated with a periphery input device such as a stylus.

It will be appreciated that other touch sensitive technologies may be employed without departing from the scope of the present disclosure. For example, sensor 114 may be configured for capacitive or resistive sensing of touches. In other embodiments, sensor 114 may be configured for multiple touch sensitive technologies.

It will also be appreciated that a peripheral input device 116 may be used to provide input to WorkSurface device 102. For example, peripheral input device 116 may include a keyboard, a mouse, a remote, a joystick, etc. and may be used to control aspects of WorkSurface device 102. In alternative embodiments, in contrast to standard computing devices, WorkSurface device 102 may not include a keyboard. In other alternative embodiments, WorkSurface device 102 may include neither a physical keyboard nor a virtual representation of a keyboard.

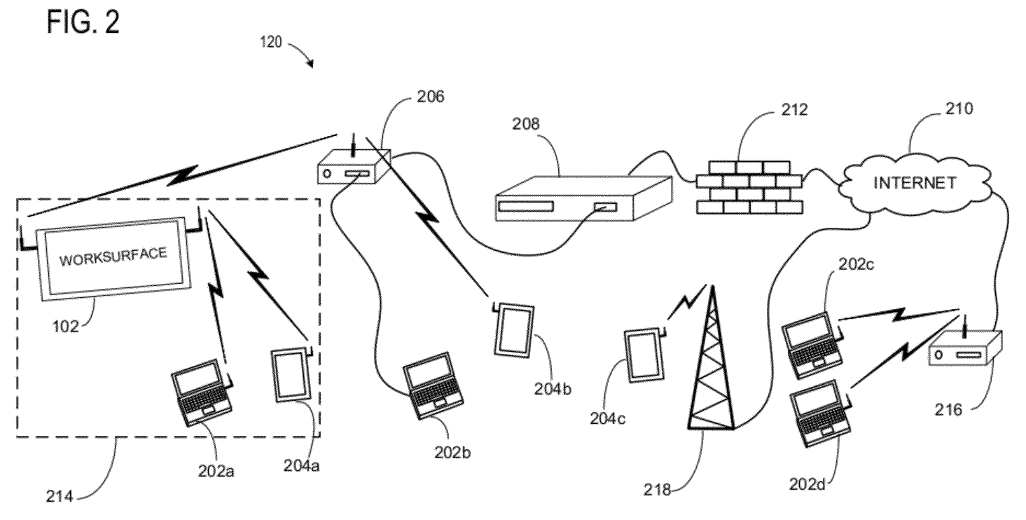

WorkSurface device 102 may include mass storage unit 110, such as a hard drive. Mass storage unit 110 is configured to be in operative communication with display 104, processor 106, and memory unit 108 via a data bus (not shown), and is configured to store programs that are executed by processor 106 using portions of memory 108, and other data utilized by these programs. For example, mass storage unit 110 may store a communication module 112. Communication module 112 may be configured to establish a communicative link between WorkSurface device 102 and one or more other computing devices. For example, in some embodiments, communication module 112 may communicate with networking module 109 in order to connect to remote users. In some embodiments, networking module 109 may include a network interface 117 that allows network connectivity between WorkSurface device 102 and network 120, discussed in more detail below and with respect to FIG. 2. The communicative link may allow users to interact with WorkSurface device 102 via a user computing device. In this way, a user may provide input to their personal computing device and have that input translate to WorkSurface device 102 if a communicative link is established between the user computing device and WorkSurface device 102. In an alternative embodiment, communications module 112 may be configured to establish a communicative link between WorkSurface device 102 and one or more external storage devices. The communicative link may allow users to quickly share files located on the external storage devices with WorkSurface device 102. For example, a user may have a presentation stored on a user computing device and a USB storage device. In some embodiments, the user may establish a communicative link between the USB storage device and WorkSurface device 102 in order to avoid losing battery life on the user computing device.

In some embodiments, communication module 112 may include and/or be operatively coupled with a camera 118. In some embodiments, camera 118 may be included in a collaboration module 119. In additional or alternative embodiments, camera 118 may be communicatively coupled to display 104. For example, in some embodiments, camera 118 may capture video images and/or still images of the interactive and collaborative computing environment 100. In this way, camera 118 may provide visual feedback to participating users of a WorkSurface session. For example, the visual feedback may be a video feed of a conference room, and the video feed may be displayed on display 104. The video feed may be provided to a user computing device located remotely with respect to WorkSurface device 102 so that remote users may view activity in the conference room. Additionally, communication module 112 may be configured to receive visual feedback, such as a video feed, from one or more user computing devices.

In some embodiments, mass storage unit 110 may include a control module 113. For example, in some embodiments, control module 113 may allow WorkSurface device 102 to be controlled by a remotely located device, such as source device 122. In alternative embodiments, control module 113 may allow WorkSurface device 102 to be controlled by any device, such as a device connected to WorkSurface device via a Universal Serial Bus (USB) port.

Mass storage unit 110 may store one or more programs associated with the interactive and collaborative computing device, such as a presentation program, a conference program, an interactive whiteboard application, or other suitable program executing on the computing device. For example, mass storage unit 110 may store programs configured to operatively run the following file formats: PPT(X), DOC(X), XLS(X), PDF, FLV, JPEG, BMP, PNG, GIF, TIFF, WMV, MPEG, WMA, MP3, etc. The communication module 112 and program(s) may be executed by processor 106 of WorkSurface device 102 using portions of memory 108.

WorkSurface device 102 may include removable computer readable media 180. Removable computer readable media 180 may be used to store and transfer data and/or instructions executable to perform the methods described herein. Examples of removable computer readable media 180 include, but are not limited to, CDs, DVDs, flash drives, and other suitable devices.

Environment 100 may also include one or more other computing devices such as source device 122. Source device 122 may be a user computing device such as a laptop, desktop, tablet, smart phone, and/or other suitable computing device. Source device 122 may include components similar to those of WorkSurface device 102, such as display 124, sensor 134, processor 126, memory unit 128, mass storage unit 130, communication module 132, camera 138, various programs 144, and removable computer readable storage media 190. The aforementioned components of source device 122 may perform similar functions to those of WorkSurface device 102 and therefore will not be discussed at length. Briefly, mass storage unit 130 may include communication module 132 and one or more programs 144 configured to establish a communicative link with WorkSurface device 102.

Source device 122 may be communicatively linked to WorkSurface device 102 via a network 120. It will be appreciated that network 120 may include an enterprise LAN, a mini-LAN via an embedded access point or attached Ethernet cable, or other network. Further, participants outside of an enterprise LAN may connect to WorkSurface device 102 by way of an office communication server, such as an OCS edge server and a Public Switched Telecommunications Network (PSTN) bridge, for example.

FIG. 2 schematically shows various example network connections in an embodiment of network 120 shown linking user computing devices in communication with the interactive and collaborative computing device (WorkSurface device 102) of FIG. 1. Establishing such a network between devices enables users to email data files, push data via network file sharing, pull data from network file shares, etc. As an example, in FIG. 2 the devices and communication protocols may vary within the network. For example, WorkSurface device 102 may be wirelessly connected directly to a laptop 202a and mobile device 204a, which may include a smart phone or tablet. WorkSurface 102 may also be wireles sly connected to router 206a. Router 206a may provide a wired communicative connection to WorkSurface 102 through, for example, a corporate local area network (LAN) to laptop 202b and a wireless communicative connection to WorkSurface 102 to mobile device 204b. Router 206a may have a wired connection to gateway 208, which connects the router 206a and associated devices to the internet 210 through firewall 212.

Establishing a connection to the internet 210 may allow the devices directly connected to the WorkSurface device 102, for example devices within conference room 214, to be able to communicate with remote devices located across the world. For example, hot spot 216 may provide a wireless connection to the internet 210 for laptop 202c and laptop 202d. Additionally, 3G tower 218 may provide internet connectivity to mobile device 204c via a wireless connection.

Turning back to FIG. 1, it will be appreciated that one or more servers 140 may be in communication with WorkSurface device 102 and source device 122 via network 120 to facilitate communication between WorkSurface device 102 and source device 122. In some embodiments, server 140 may include a WorkSurface-web-server, and as such, may facilitate file uploads, player control, and display monitoring, for example. Server 140 may also be configured to allow remote viewing of a presentation, remote administrative control of WorkSurface 102, and other functions from a remote environment. In this way, WorkSurface 102 may be configured for cloud-based file sharing and collaboration.

Further, more than one WorkSurface device may be networked such that groups of users in different locations may each have a WorkSurface device with which to interact. In this way, more than one WorkSurface device may communicate and cooperate to display contributions from users in each location. As another example, one WorkSurface device may broadcast a display to another WorkSurface device or another computing device, such as a large format smart display, for providing a visual of the WorkSurface session to an audience.

It will be appreciated that source device 122 may be a local computing device or a remote computing device, relative to the physical location of WorkSurface device 102. Put another way, a user of source device 122 need not be near WorkSurface device 102 in order to collaborate with other users and/or audience members. In some embodiments, source device 122 may include a camera 138 which may provide visuals such as a video feed of a user or a user's environment as feedback on display 104. For example, a remote user may establish a communicative link with WorkSurface device 102 during a conference session and camera 138 may capture images and/or a live video feed of the user and provide and/or send those images and/or video feed to WorkSurface device 102 for display.

As described in more detail below with reference to FIGS. 2-5, WorkSurface device 102 may function as an interactive and collaborative computing device, enabling users to actively participate in a session and share information through the familiarity of their own computing device.

FIG. 3 shows various example capabilities (described as endpoints in FIG. 3) of the interactive and collaborative computing device (WorkSurface device 102) of FIG. 1 in an embodiment of interactive and collaborative environment 100.

As shown, WorkSurface device 102 may present a multimedia presentation to an audience via display 104. The presentation capabilities of WorkSurface device 102 may enable collaboration with other users via one or more different interfaces/platforms. For example, WorkSurface device 102 may be a liquid crystal display (LCD) flat panel display device with a touch interface overlay that is compatible with various conferencing programs/interfaces such as WEBEX, GOTOMTG, OCS, VTC client, etc. Additionally, WorkSurface device 102 may be configured for peripheral A/V and/or embedded A/V capabilities by providing various peripheral interfaces. WorkSurface device 102 may be configured to include an embedded or integral PC, enabling WorkSurface device 102 to display a presentation using WINDOWS™-based software, for example. WorkSurface device 102 may provide unified control for a plurality of devices or applications, and may be compatible with a plurality of management clients, embedded or peripheral video and/or audio players, whiteboard applications, and various other applications that facilitate audio, video, and image connectivity. Further, WorkSurface device 102 may be operatively coupled to a WorkSurface presentation endpoint such as projector 302, which for example may include projection-controlling LITEBOARD interactive technology. Accordingly, it will be appreciated that various suitable and customizable endpoints may be provided by WorkSurface device 102. For example, customizable endpoint 304a, WorkSurface collaboration endpoint 304b, WorkSurface conferencing endpoint 304c, and WorkSurface media endpoint 304d may provide any combination of the features described above in order to facilitate multimedia presentation and collaboration among people. WorkSurface media endpoint 304d may be directed toward targeted spaces, utilizing certified players and management clients.

As explained above, in some embodiments, WorkSurface device 102 may be used for a conference to enable collaboration between participants of the conference. For example, in the embodiment shown in FIG. 3, a conferencing network may be established in which WorkSurface devices 102a and 102b provide a multi-display network to groups of users. The conferencing network utilizing WorkSurface devices 102a and 102b may include presence detection and moderated visualization in order to control functionality of the multi-display configuration. As described in more detail below, users may contribute to the WorkSurface conferencing network by annotating the displayed content. Annotated input may be received either directly to the display of WorkSurface device 102a or 102b, or indirectly through detected input from another computing device communicatively linked to WorkSurface device 102a and/or 102b. For example, one or more user computing devices communicatively linked to WorkSurface device 102a and/or 102b may provide annotated input. Upon receiving input from a user computing device, display 104 may be altered accordingly.

In some embodiments, WorkSurface device 102 may be configured for internet access through a browser to enhance a presentation, for example. Further, in some embodiments, WorkSurface device 102 may be configured to display an interface associated with more than one application/program concurrently. For example, the WorkSurface display may include a portion of the display dedicated to the presentation file, a portion dedicated to an internet browser, and a portion dedicated to a video feed from a remote location. It will be appreciated that such portions may be displayed in any suitable size concurrently or alternatively. As one example, the entire display may be dedicated to the presentation to maximize the usable space, and if another application/program be accessed during the presentation, a user may seamlessly switch between applications/programs without experiencing downtime.

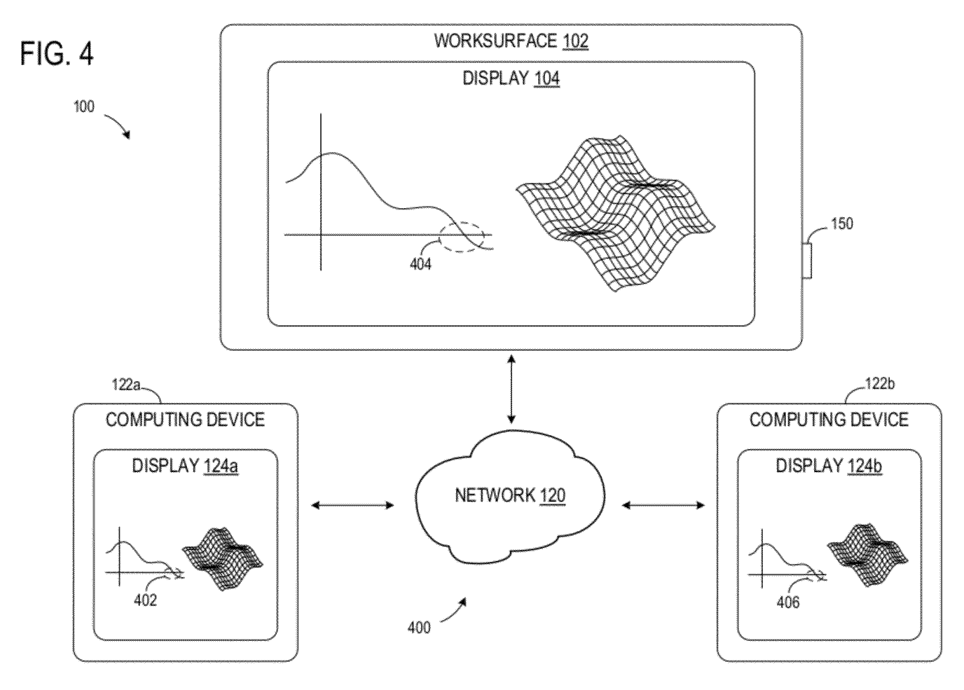

FIG. 4 schematically shows an embodiment of a communicative link 400 between the interactive and collaborative computing device (WorkSurface device 102) of FIG. 1 and computing devices 122a and 122b. For example, the embodiment of WorkSurface device 102 shown in FIG. 4 may include an “interactive whiteboard”. For example, an interactive whiteboard may be used in an interactive and collaborative environment 100 as a way to display content and annotate content shown on display 104.

In one example, WorkSurface device 102 may be configured to receive input from a user via source device 122 and display such input as an annotation of the original. For example, a member of the audience may have a mobile computing device that is communicatively linked to WorkSurface device 102. The member may interact with the presentation so that the member's interaction is displayed to the audience. For example, the member's interaction may be a comment, question, suggestion, or other contribution displayed near the original presentation. In this way, the member may annotate the presentation on display 104. Thus, members of the audience may collaborate with the presenter by participating in the presentation and providing input visually through use of a mobile computing device or other suitable source device 122.

Using FIG. 4 as an example, a member of an audience wishes to address a certain feature on the display. Rather than describing the feature verbally, the audience member may provide input by touching the feature as shown on a display of their personal computing device. For example, a user of computing device 122a may circle a point where a graph crosses an axis, which is indicated at 402. If computing device 122a has established a communicative link with WorkSurface device 102, then a circle 404 may appear on display 104 for the audience to see. Circle 404 may be described as an annotation to the original content on display 104. Further, the annotation may be displayed on the displays of other computing devices communicatively linked to WorkSurface device 102. As shown, computing device 122b shows a circle at 406 on display 124b that corresponds to circle 402 and 404.

In some embodiments, annotations may be associated with an identifying feature to identify the individual who contributed the annotation to the original. For example, a user may highlight an annotation on WorkSurface device 102 and/or on a user computing device to reveal an indication, such as a text box, an icon, or other visual display that identifies who contributed the annotation. Such a feature may help distinguish annotations made by different users.

As shown in FIG. 4, users of computing devices 122a and 122b may interact with WorkSurface device 102 using an interactive whiteboard application, for example. Users may contribute annotations to images shown on display 104 and likewise on displays 124a and 124b, as described above. In this way, annotations may be drawn and viewed from multiple communicatively linked displays. Further, such annotations and other annotations to files associated with other applications and programs may be saved and distributed to each user via email, for example.

Additionally or alternatively, in some embodiments, annotated files may be transferred to a memory device, such as a flash drive, via a compatible communication port. For example, WorkSurface device 102 may include universal serial bus (USB) port 150 to facilitate the transfer of data between WorkSurface device 102 and a memory device such as an external storage device (e.g., uploading and downloading) and to allow communicative coupling between WorkSurface 102 and one or more user computing devices. As shown in FIG. 4, USB port 150 extends from WorkSurface 102, however it will be appreciated that this illustration is for ease of understanding and is not limiting. USB port 150 may be configured such that it is recessed from an outer surface of WorkSurface 102 and/or integral to display 104.

It will also be appreciated that various devices in communication with WorkSurface device 102 may include displays of different sizes than that of display 104. Accordingly, various techniques may be utilized to accommodate this potential difference in size. For example, content viewed on displays 124a and 124b may be adjusted to show the content of display 104. Further, displays 124a and 124b may be scrollable and/or zoomable such that different portions of each display may be accessed by a user to view content of display 104.

It will be appreciated that FIG. 4 is provided as a non-limiting scenario. Thus, users may collaborate, generate ideas, and clarify concepts in any suitable way without departing from the scope of the present disclosure. Further, it will be appreciated that annotations to the content viewed on display 104 may have any suitable form including, but not limited to, text, audio, and animation. While an interactive whiteboard application is provided as an example, it will be appreciated that other programs and applications may be configured to receive annotated input and display such annotations on one or more displays during a WorkSurface session. Further, it will be appreciated that users may provide annotation input whether the user is locally or remotely located.

As another example, in some embodiments, two or more simultaneous user inputs associated with two or more user computing devices may be concurrently displayed on each of the WorkSurface devices and user computing devices participating in the WorkSurface session. Allowing simultaneous and/or concurrent user inputs may reduce delay during real-time collaboration, in comparison to sessions allowing only sequential user inputs. It should be appreciated that in alternative embodiments, two or more simultaneous user inputs may not be simultaneously displayed on each device participating in the WorkSurface session, in order to reduce the processing power requested by the WorkSurface session in comparison to sessions allowing simultaneous multi-user input.

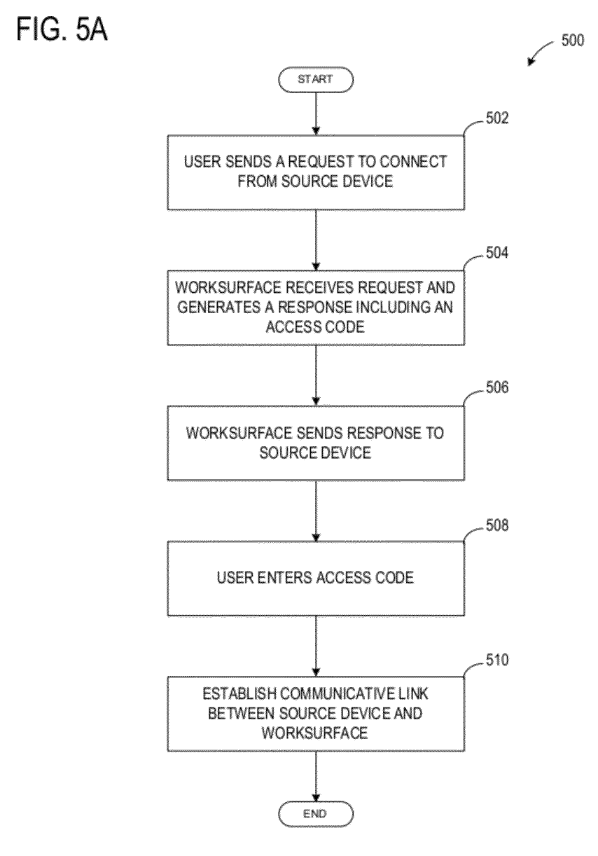

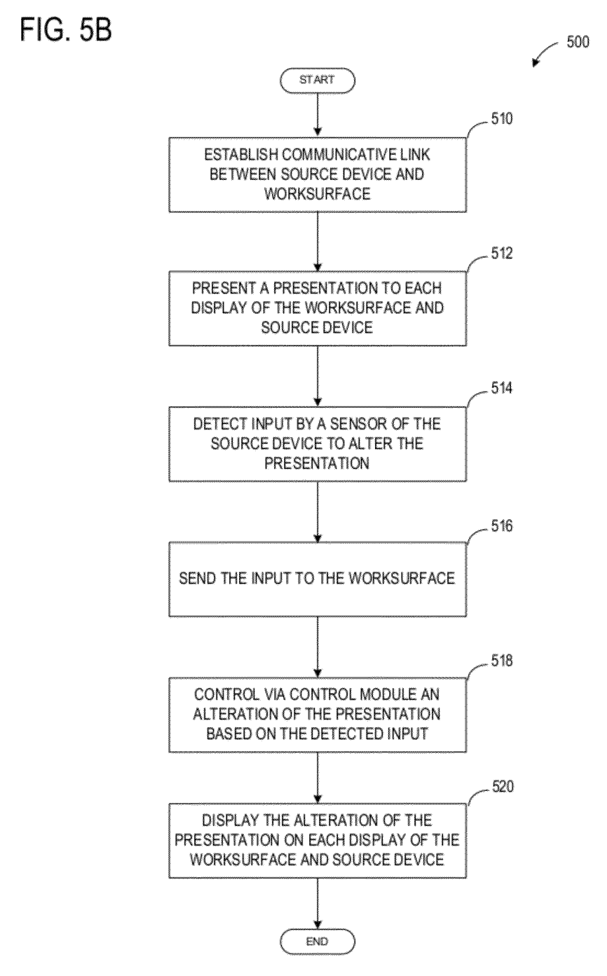

FIG. 5A shows an embodiment of a method 500 for communicatively linking a user computing device (e.g., source device 122 of FIG. 1) to the interactive and collaborative computing device (e.g., WorkSurface device 102) of FIG. 1. At 502, method 500 includes sending a request to connect from the user computing device to the WorkSurface device. For example, the request may be an electronic message such as an email. The request may include text and/or other identifying features that indicate a user's request to join a WorkSurface session. For example, the request may include information that identifies a particular WorkSurface device and/or a particular WorkSurface session.

Further, the request may include an indication of a user request to communicatively connect to the WorkSurface device before or after a session. For example, a user may wish to upload a file to the WorkSurface device prior to a presentation. Further, a user may wish to download a file from the WorkSurface device following a presentation. For example, a presentation session may include various annotations to the presentation file from one or more participating users. Downloading a file from the WorkSurface device following a presentation gives each participating user the opportunity to leave the session with a copy of the annotated file. In some embodiments, files may be available to download at anytime, or alternatively, files may be available to download for a predetermined amount of time and unavailable for downloading after the predetermined amount of time has lapsed.

Turning back to FIG. 5A, at 504 method 500 includes receiving the request, wherein the WorkSurface device is configured to automatically detect the receipt of the request and generate a response to the request to connect to the WorkSurface device. Additionally or alternatively, a user of a WorkSurface session (e.g., a local user) may provide input to the WorkSurface device to facilitate the distribution of the response after receipt of a user request. The generated response may also be in the form of an electronic message such as an email. The generated response may include access information, such as an access code, that may serve as a key to gain access to a WorkSurface session. It will be appreciated that the generated response may include additional and/or alternative information for communicatively linking a user computing device to the WorkSurface device.

In some embodiments, access codes associated with the WorkSurface device may be dynamic. For example, the WorkSurface device may be configured to generate a random access code at predetermined intervals. Additionally or alternatively, in some embodiments, access codes generation may coincide with a particular WorkSurface session. For example, a scheduled WorkSurface session may have a designated access code that may allow a user to access features on the WorkSurface device associated with that particular WorkSurface session before, during, and/or after the session. It will also be appreciated that the WorkSurface access code may be static in some embodiments.

At 506, method 500 includes sending the generated response from the WorkSurface device to the user computing device. As described above, the generated response may include an access code enabling a user to connect to the WorkSurface device via the user computing device. It will be appreciated that the user (and likewise the user computing device) may be located locally or remotely relative to the WorkSurface device to establish a communicative link.

At 508, method 500 includes a user entering the access code to establish a communicative link with the WorkSurface device. In some embodiments, the access code may be provided as input via the user computing device. As described above, the access code may be dynamic and may be generated randomly. In such embodiments, the access code may be time sensitive. For example, a particular access code may expire after a predetermined period of time and thereafter may not be used to establish a communicative link with the WorkSurface device. Alternatively, in some embodiments, an access code may be indefinitely viable and may be used to establish a communicative link. In such cases, the access code may allow a user to access some features of the WorkSurface device wherein other features may not be available. It will be appreciated that such access controls may be customizable by an administrative user, or administrator, of the WorkSurface device. It should be appreciated that the terms administrative user and administrator may be used interchangeably herein.

In some embodiments, once a communicative link has been established between devices, certain features of the WorkSurface device may be associated with an additional access code. For example, a presentation file that has been previously uploaded to the WorkSurface device may be accessed after successful entry of a presentation access code. It will be further appreciated that features, such as additional security measures, of WorkSurface device may be customizable by an administrator who has administrative access to the WorkSurface device.

At 510, method 500 includes establishing a communicative link between the user computing device and the WorkSurface device. Upon establishing the communicative link, the user may interact with the WorkSurface device and/or collaborate with other users who have established a communicative link with the WorkSurface device. In this way, the WorkSurface device is an interactive and collaborative computing device. Various features of the WorkSurface device, as described herein, may be used by the users connected to the WorkSurface device to share information, brainstorm, provide an interactive learning experience, etc. For example, business partners may conduct a video conference call with overseas colleagues by establishing a WorkSurface session. Each person may collaborate by providing input via the WorkSurface device and/or a personal computing device. As another example, a teacher may present a lecture using a WorkSurface device and students may participate in the lecture by providing input through the WorkSurface device and/or a personal computing device such as source device 122. The input may be detected by a sensor of the WorkSurface device and/or the personal computing device, and in response to the input, the WorkSurface device and/or the personal computing device may display a response to the detected input on a corresponding display of the WorkSurface device and/or the personal computing device.

In one example embodiment, a user may send an email from a user computing device to a WorkSurface device requesting to connect to the WorkSurface device. For example, the email may contain a session ID to which the user is requesting to be added. Upon receiving the email, the WorkSurface device may generate an access code relating to the email sent by the user and the requested session ID. The WorkSurface device may then send the access code, an alternate link in case an access code does not work, and a message indicating a connection allowance as a reply email to the email address of the user. Upon receiving the email, the user may navigate to a web page pertaining to the session ID, and enter the access code in an access code field of the web page. Upon submitting the access code, the user is connected to the WorkSurface device, and may proceed to view a presentation, annotate the presentation, communicate with other users of the session, etc.

FIG. 5B shows an embodiment of a method 500 for presenting and altering a presentation on the interactive and collaborative computing device after communicatively linking a user computing device (e.g., source device 122 of FIG. 1) to the interactive and collaborative computing device (e.g., WorkSurface device 102) of FIG. 1. FIG. 5B continues from step 510 of FIG. 5A, wherein a communicative link is established between the source device and the WorkSurface device. At 512, a presentation may be presented to the display of the WorkSurface device (e.g. display 104) and the display of the source device (e.g. display 124). For example, in some embodiments, a PDF presentation may be displayed on each display of the WorkSurface device and the source device. In alternative embodiments, a POWERPOINT™ presentation may be display on each display of the WorkSurface device and the source device. In still other alternative embodiments, the presentation may include any suitable content, such as a whiteboard collaborative application.

At step 514, an input may be detected by a sensor of the source device. In some embodiments, the input may provide an alteration to the presentation. For example, in some embodiments, the input may provide an annotation to the presentation. In alternative or additional embodiments, the input may be directed toward a control of the presentation. For example, in some embodiments, the input may be directed toward advancing a presentation to a next page or slide, closing a presentation, opening a different application, and/or any other suitable control. It should be appreciated that in some embodiments, any suitable input to alter the presentation may be detected by a sensor of the source device at step 514.

At step 516, the input is sent to the WorkSurface device. For example, in some embodiments, the input may be sent over network 120 to network interface 117 and received by the control module 113 of WorkSurface device 102. Alternatively, in other embodiments, the input may be sent over USB. At step 518, a control module of the WorkSurface device may control an alteration of the presentation based on the detected input. For example, in some embodiments, the detected input may be an annotation of the presentation, and the control module may annotate the presentation according to the input. In alternative embodiments, the detected input may be an advancement to a next page and/or slide of the presentation, and the control module may control the presentation to advance to the next page and/or slide.

At step 520, the alteration of the presentation is displayed on the display of the WorkSurface device and the display of the source device. For example, in some embodiments, the alteration may be an annotation of the presentation, and the presentation may be annotated such that the annotated presentation is displayed on each display connected to the WorkSurface device. In alternative embodiments, the alteration may be an advancement to a next page and/or slide of the presentation, and each display of the WorkSurface device and source device may display the next page and/or slide of the presentation accordingly.

It will be appreciated that the embodiment of method 500 shown in FIGS. 5A and 5B and described above is provided by way of example and may include additional and/or alternative steps than those shown in FIGS. 5A and 5B. As one non-limiting example, method 500 may include additional steps to impart additional security features when establishing a communicative link between the WorkSurface device and one or more user computing devices.

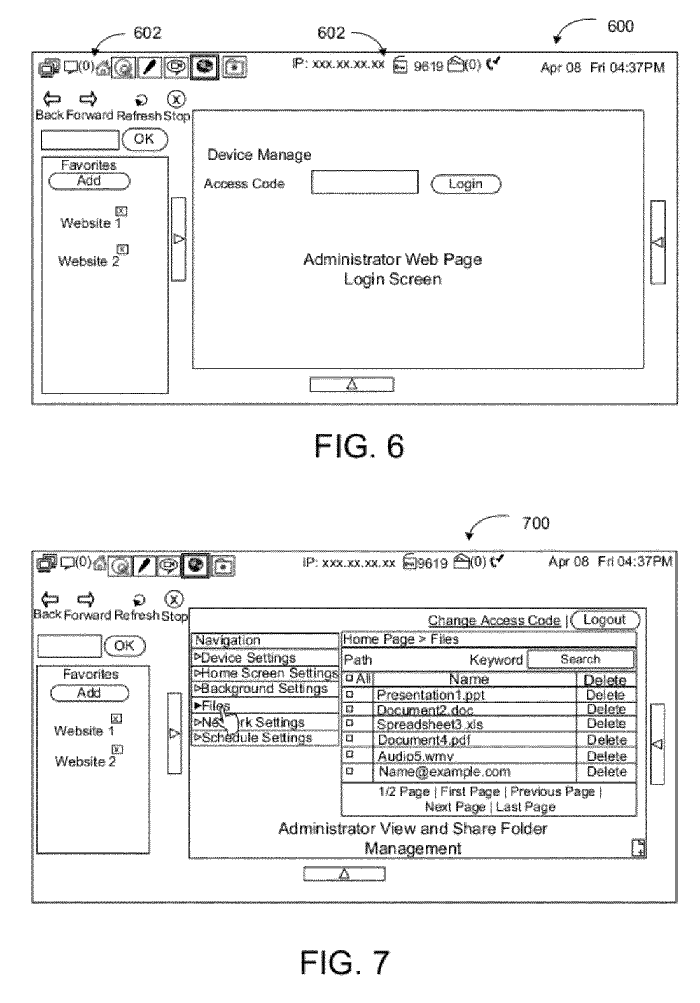

FIGS. 6-25 show embodiments of graphical user interfaces (GUIs) of the interactive and collaborative computing device (WorkSurface device 102) of FIG. 1 that may be provided as visuals on a display. It will be appreciated that while the GUIs shown in FIGS. 6-25 are associated with the display of WorkSurface device 102, similar GUIs may be shown to a user on the display of the user's computing device when in communication with WorkSurface device 102. Further, it will be appreciated that the GUIs are provided by way of example and are not meant to be limiting in any way. While the descriptions provided below occasionally refer to WINDOWS™ or WINDOWS7™ it will be appreciated that any suitable operating system may be used without departing from the scope of the present disclosure.

FIGS. 6-10 show embodiments of administration GUIs associated with various administrative features that may be displayed on the WorkSurface device. FIG. 6 shows an example administrative login screen GUI 600. In some embodiments, the WorkSurface device may be configured to enable remote administrative login using a web-based administrative login interface. For example, logging into the WorkSurface device as an administrator may grant access to various features of the WorkSurface device that may be unavailable to other users of the device. In this way, the WorkSurface device may be customizable by an administrator.

As an example, in some embodiments, once the administrator gains access to administrative controls by completing an administrative login procedure on an administrative user device, which may be the WorkSurface device or a user computing device, the administrator may customize the WorkSurface device. In some embodiments, the administrative user device is the WorkSurface device, and the administrative user may provide input to the WorkSurface device via at least one of touch input directed to a display of the WorkSurface device and one or more peripheral input devices communicatively coupled to the WorkSurface device. Alternatively, in other embodiments, the administrative user device may be a user computing device, and the administrative user may provide input to the WorkSurface device via the user computing device.

In some embodiments, GUI 600 may include various graphical and/or textual elements 602. For example, elements 602 may provide notifications to the user regarding message delivery, status of connectivity to a network and/or device, date and/or time, information pertaining to the WorkSurface device or user computing device displaying GUI 600, etc. In some example embodiments, elements 602 may also include an indication of an application in use. For example, icons representing various applications, such as View and Share, Whiteboard, Video Conferencing, Internet Browser, Applications, etc., may be displayed, with an identifying element provided for an application that has a user's focus. In some embodiments, such an identifying element may include a highlight, a change in color, a change in size, an animation, and/or any other suitable mechanism to identify a particular application.

Further, in some embodiments, one or more of elements 602 may be selectable. For example, in some embodiments, a user may select a message icon in order to navigate to a message screen so that the user may quickly view newly received messages. In additional or alternative embodiments, a user may select a particular application element in order to navigate to the associated application. In further additional or alternative embodiments, a user may select an element in order to view more information related to the selected element, change settings related to the selected element, and/or perform any suitable action related to the selected element. It should be appreciated that in alternative embodiments, none of the elements 602 may be selectable.

FIGS. 7-10 show example GUIs that may be available after a successful administrative login.

FIG. 7 shows an example view and share folder GUI 700 that an administrative user may manage. In some embodiments, such a folder may include files that have been uploaded by various users who have established a communicative link with the WorkSurface device. In some embodiments, the view and share folder may include files that have been uploaded to the WorkSurface device via a USB port. The view and share folder may also contain files that have been annotated during a WorkSurface session. Further, an administrative user may define the type of files that may be uploaded and/or downloaded to/from the WorkSurface device. Accordingly, a list of files that are accessible to one or more WorkSurface devices and/or user computing devices during a presentation of the host WorkSurface device may be displayed on the one or more WorkSurface and/or user computing devices, however this list may be limited to include file types approved by the administrative user. Further, in some embodiments, the list may be only limited on WorkSurface and user computing devices that are not the host WorkSurface device and/or the administrative user device.

In some embodiments, for example, the host WorkSurface device and/or the administrative user device may display a full list of files that are in a shared folder, while other devices may display only PDF and POWERPOINT™ files that are in the shared folder, in a case where the administrative user approved only PDF and POWERPOINT™ files to be accessible. Alternatively, in other examples, the administrative user may approve any number and type of files to be accessible by devices other than the WorkSurface device and/or the administrative user device. For example, the administrative user may approve one or more of PPT(X), DOC(X), XLS(X), PDF, FLV, JPEG, BMP, PNG, GIF, TIFF, WMV, MPEG, WMA, MP3, or any other suitable file types. In other examples, the administrative user may approve zero file types. In still other examples, the administrative user may approve all file types.

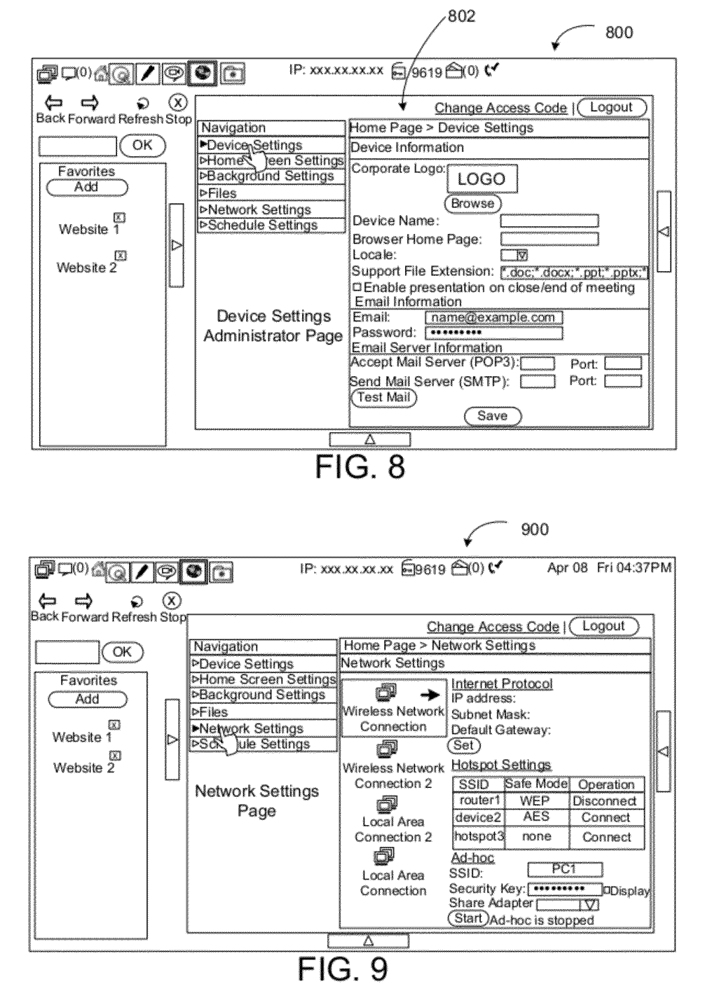

FIG. 8 shows an example device settings administrative page 800. In some embodiments, administrative controls 802 may include, among other elements, device access controls, user access controls, presentation controls, and/or user contact list controls in order to enable an administrator to define access parameters to various programs and applications, as well as adjust various settings for the WorkSurface device. An administrator may control the enabling/disabling of various devices communicatively linked to the WorkSurface device. The administrator may control the enabling/disabling with device access controls. For example, an administrator may control settings for a whiteboard application such that users may not contribute annotations, and in this way the users may not contribute annotations. Alternatively, an administrator may control settings for the whiteboard application such that users are permitted to make annotations.

FIG. 9 shows an example network setting GUI 900. In some embodiments, such a GUI may enable an administrator and/or another user to define the network settings in association with a WorkSurface network/session.

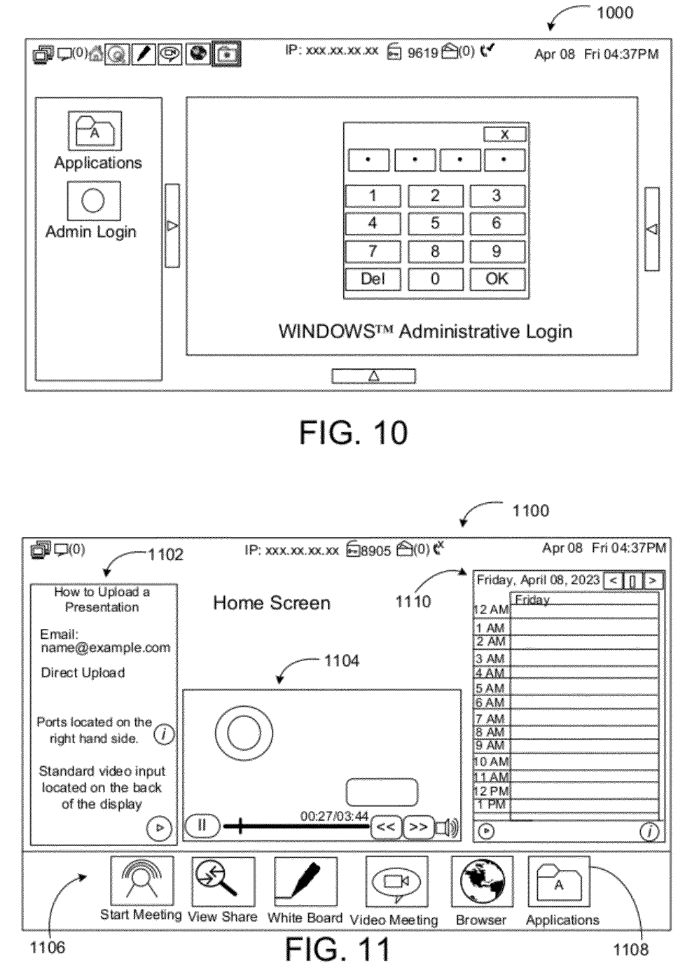

FIG. 10 shows an example WINDOWS™ administrative login GUI 1000. For example, in some embodiments, a WINDOWS™ administrative login page may provide access to administrative controls for a WINDOWS™ based operating system.

Additionally, in some embodiments, an administrator may define a contacts list that saves information associated with users that may establish a communicative link with the WorkSurface device. It will be appreciated that other administrative controls are possible without departing from the spirit of this disclosure and that the above examples are meant to be non-limiting.

FIGS. 11-15 show example GUIs associated with various home screen features that may be displayed on the WorkSurface device. For example, as shown in FIG. 11, a home screen GUI 1100 may include instructions 1102 for how to connect to the WorkSurface device. Such instructions may enable local users to easily view said instructions and begin a protocol for uploading a presentation via establishing a communicative link with their personal computing device and/or directly through a USB port of the WorkSurface device. Accordingly, the instructions 1102 may provide instructions for connecting a user computing device directly or indirectly to the WorkSurface device 102. The home screen may also include a live video feed 1104 of the local interactive and collaborative computing environment, for example.

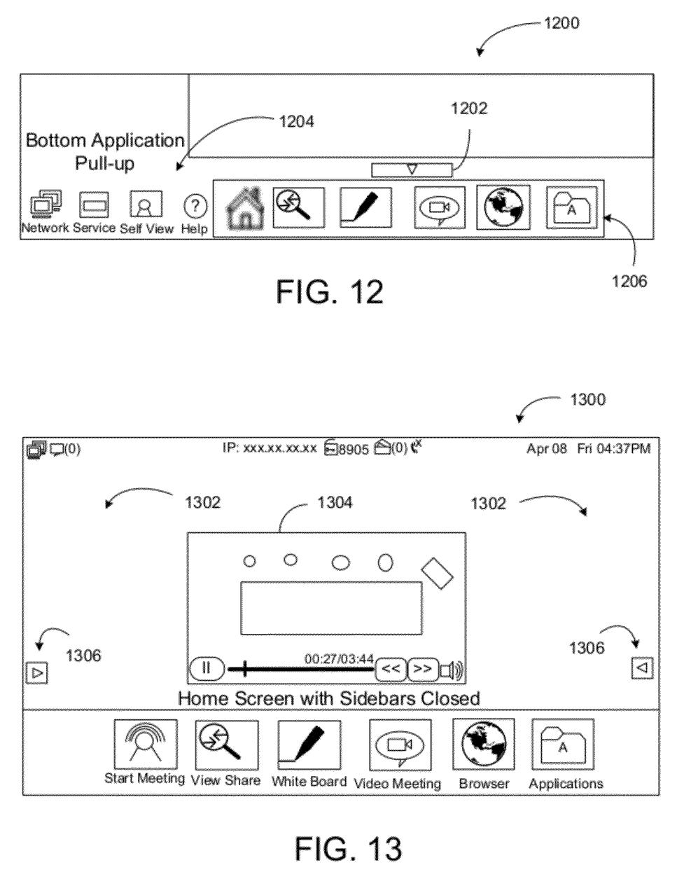

As shown in example embodiments depicted in FIGS. 11 and 12, the home screen may include controls 1106 and/or 1206 to receive input from a user to navigate to a start meeting page, a home page, a view share page, a whiteboard program, a video meeting program, an internet browser, and a page for other applications, for example. In some embodiments, controls 1106 and/or 1206 may include any suitable number of selectable icons 1108 that may allow the WorkSurface device to receive input from a user to navigate to an associated page. In some embodiments, the home screen may also include an agenda, calendar, and/or other task list, as shown at 1110 in FIG. 11, for example.

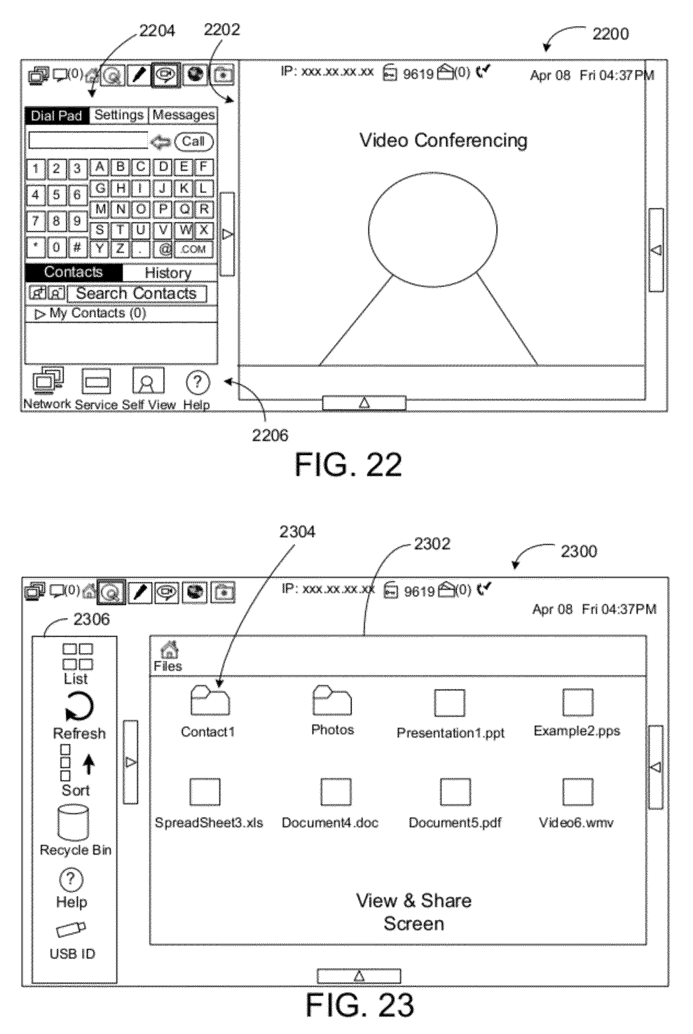

As shown in an example embodiment depicted in FIG. 12, the bottom application pull-up may allow a user to view various forms of controls 1106 and/or 1206. For example, a user may click on tab 1202 in order to switch between views. In one embodiment, the views may include any of an icon view, for example as shown in FIG. 12, an icon and text description view, for example as shown in FIG. 11, and a hidden view, for example as shown in FIG. 10. In some embodiments, the icons 1108 may be customizable. For example, controls 1106 and/or 1206 may include only icons selected by a user. Additionally or alternatively, in other examples, icons 1108 may be arranged in an order and/or positioning configurable by a user. It should be appreciated that the icons shown in the figures are exemplary and any suitable number, type, or arrangement of icons may be included in controls 1106 and/or 1206. Further, as shown in GUI 1200, in some embodiments, additional controls 1204 may be displayed in accordance with an active application. These controls will be discussed in more detail below with respect to FIG. 22.

It will be appreciated that the home screen may include virtually any suitable information, and further, that such information and/or the view of such information may be customizable. For example, in some embodiments, some icons and/or features of the home screen may be hide-able. As shown in FIG. 13, the example home screen GUI may be customizable by hiding a view of the sidebar features, as seen in closed sidebar locations 1302. As shown and compared to FIG. 11, the instructions and the agenda visuals may be sidebar features that can be hidden, while, for example, a live video feed 1304 may remain in view. However, the sidebars may be made to reappear by selection of a respective icon 1306.

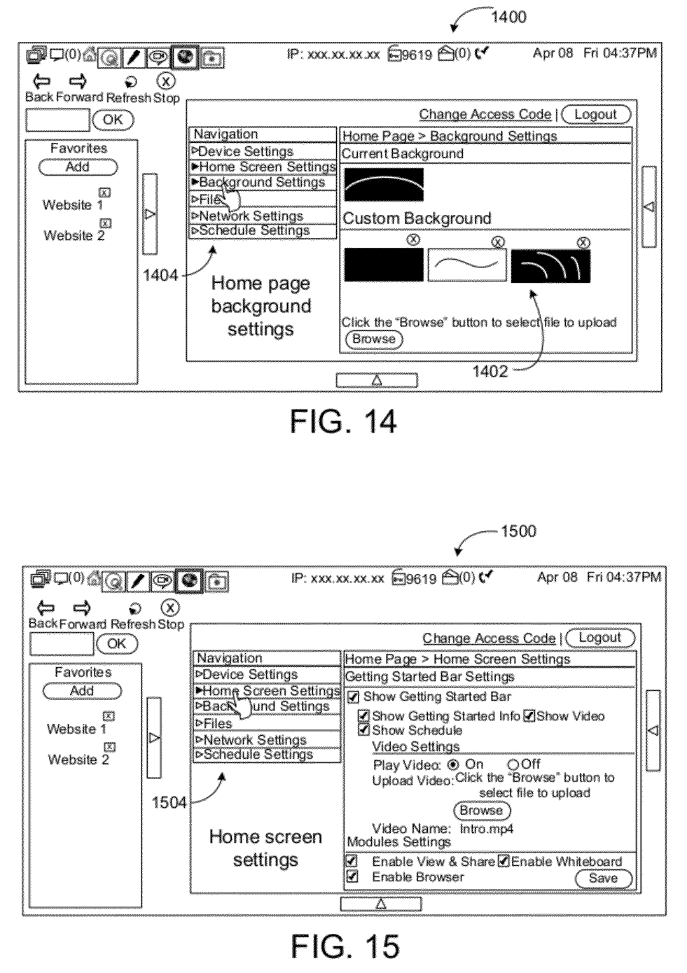

Additionally, in some embodiments, a view of the home screen may be customizable by adjusting the settings of the background, as shown in example GUI 1400 in FIG. 14, in which a plurality of background image thumbnails 1402 may be browsed for user selection. In some embodiments, a user may navigate to a background settings page from the home page by selecting the associated selectable text in navigation pane 1404. In some example embodiments, a user may provide a custom background by browsing files that are accessible to the WorkSurface device or user computing device and selecting a file to be uploaded to the custom background list. Further, in some embodiments, a user may control the background image thumbnails 1402 that appear in the custom background list by removing unwanted thumbnails. For example, a user may select a delete icon located near an unwanted thumbnail in order to remove the unwanted thumbnail from view.

Additional settings associated with the home screen may also be adjustable, and an example GUI 1500 for controlling such settings is depicted in FIG. 15. For example, a user may navigate to a home screen settings page from the home page by selecting the associated selectable text in navigation pane 1504. In some example embodiments, the home screen settings page may include features that may be turned on or off. These features may include but are not limited showing a Getting Started Bar, showing Getting Started info, showing a video, and showing a schedule. For example, a user may select a box positioned next to a feature the user allows. In some examples, the allowance of various features may be demonstrated by the appearance of a check, “x,” and/or any suitable notation within the selected box. Alternatively or additionally, in some examples, the denial of various features may be demonstrated by an empty selectable box, a change in appearance of the selectable box and/or the text description of the feature, and/or any suitable demonstration.

Further, in some example embodiments, the home screen settings may include video settings. In one example, these video settings may include turning on or off the ability to play a video. In some examples, a video may be uploaded when a user selects a browse button on GUI 1500, browses files that are accessible to the WorkSurface device or user computing device, and selects a video file to be uploaded. In some example embodiments, GUI 1500 may include modules settings. These modules settings may enable a user to select which modules to allow. In some example embodiments, these modules may include View & Share, Whiteboard, Browser, and/or any other suitable modules that may be included on the WorkSurface device or user computing device. In some example embodiments, a user may select a save button in order to save any changes made to the settings. Further, in some example embodiments, settings changes may be lost if a user does not select the save button before navigating away from the settings page. In alternative embodiments, the settings may be automatically saved. For example, in some embodiments, the settings may be saved on timed intervals, and/or may be saved upon detection of a changed setting.

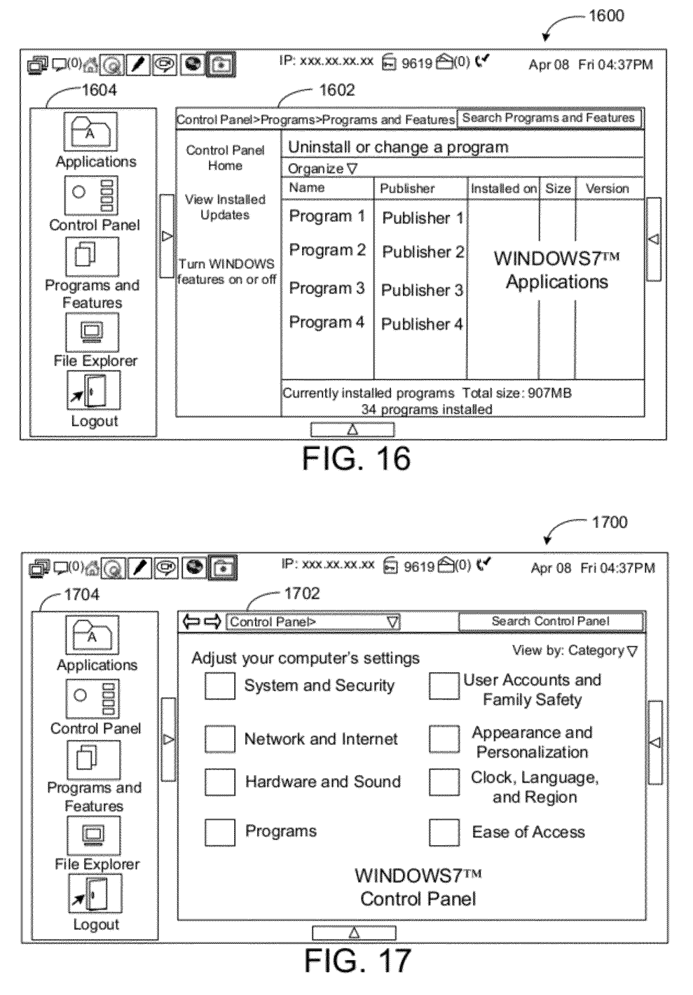

FIGS. 16-17 show example GUIs associated with example applications and control features that may be displayed on the WorkSurface device. For example, FIG. 16 shows a list GUI 1600 of available WINDOWS7™ applications. In some example embodiments, GUI 1600 may include a representation of WINDOWS7™ GUI elements, including a Programs and Features window 1602. For example, the Programs and Features window 1602 may include a list of program names, publishers, installation dates, sizes, versions, and/or any other information relating to programs installed on and/or available to the user. In some example embodiments, the Programs and Features window 1602 may include a search box to allow a user to quickly find a particular program or programs. Further, in some example embodiments, the Programs and Features window 1602 may include controls that allow a user to navigate to a Control Panel home page, view installed updates to programs, turn WINDOWS™ features on or off, and/or any other suitable controls. In one example embodiment, the Programs and Features window 1602 may provide information relating to the programs that are currently installed. In some examples, this information may include total size, number of programs installed, and/or any other information related to the group of programs installed on the WorkSurface device or user computing device.

In some example embodiments, GUI 1600 may include a sidebar 1604. For example, sidebar 1604 may include selectable icons to allow a user to control GUI 1600 and navigate to various pages. In some example embodiments, sidebar 1604 may include controls to open an Applications window, a Control Panel window, a Programs and Features window, a File Explorer window, and/or any other suitable windows. Further, in some embodiments, sidebar 1604 may include a Logout control, allowing the user to logout of a current session.

FIG. 17 shows an example WINDOWS7™ control panel GUI 1700. In some example embodiments, GUI 1700 may include a representation of WINDOWS7™ GUI elements, including a Control Panel window 1702. For example, the Control Panel window 1702 may include selectable links to adjust the settings of a computing device. In some embodiments, these settings may include System and Security settings, Network and Internet settings, Hardware and Sound settings, Programs settings, User Accounts and Family Safety settings, Appearance and Personalization settings, Clock, Language, and Region settings, Ease of Access settings, and/or any other suitable settings categories. In some example embodiments, a user may search the Control Panel in order to quickly find a particular setting or settings. In some example embodiments, a user may view settings by category. In alternative embodiments, a user may view settings by another organizational element. For example, a user may view a complete list of settings for the WorkSurface device or user computing device.

In some example embodiments, GUI 1700 may include a sidebar 1704. For example, sidebar 1704 may include selectable icons to allow a user to control GUI 1700 and navigate to various pages. In some example embodiments, sidebar 1704 may include controls to open an Applications window, a Control Panel window, a Programs and Features window, a File Explorer window, and/or any other suitable windows. Further, in some embodiments, sidebar 1704 may include a Logout control, allowing the user to logout of a current session.

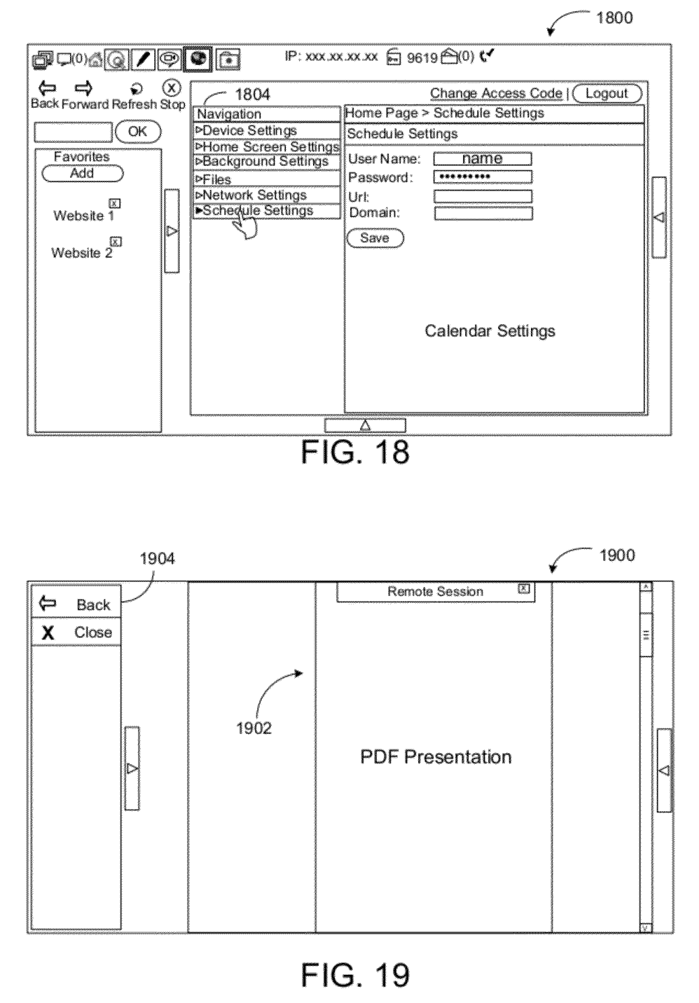

FIG. 18 shows an example calendar settings GUI 1800 that may be used to schedule WorkSurface sessions, change calendar settings, and/or keep track of other tasks, meetings, deadlines etc. Adding a record to the calendar may include providing a user name and a password; however it will be appreciated that adding a record to the calendar may be provided without a user name and a password in some embodiments. In some example embodiments, a user may navigate to a schedule settings page from the home page by selecting the associated selectable text in navigation pane 1804. In some example embodiments, a user may create or alter a user name and password to the schedule settings page, which may change the user name and password requested by the calendar when adding a record to the calendar in some embodiments. It should be appreciated that user name and password settings may be omitted or may be applied to a different element for alternative embodiments, in which a user name and password are not provided when adding a record to the calendar.

In some example embodiments, a user may select a save button in order to save any changes made to the calendar settings. Further, in some example embodiments, settings changes may be lost if a user does not select the save button before navigating away from the schedule settings page. In alternative embodiments, the settings may be automatically saved. For example, in some embodiments, the settings may be saved on timed intervals, and/or may be saved upon detection of a changed setting.

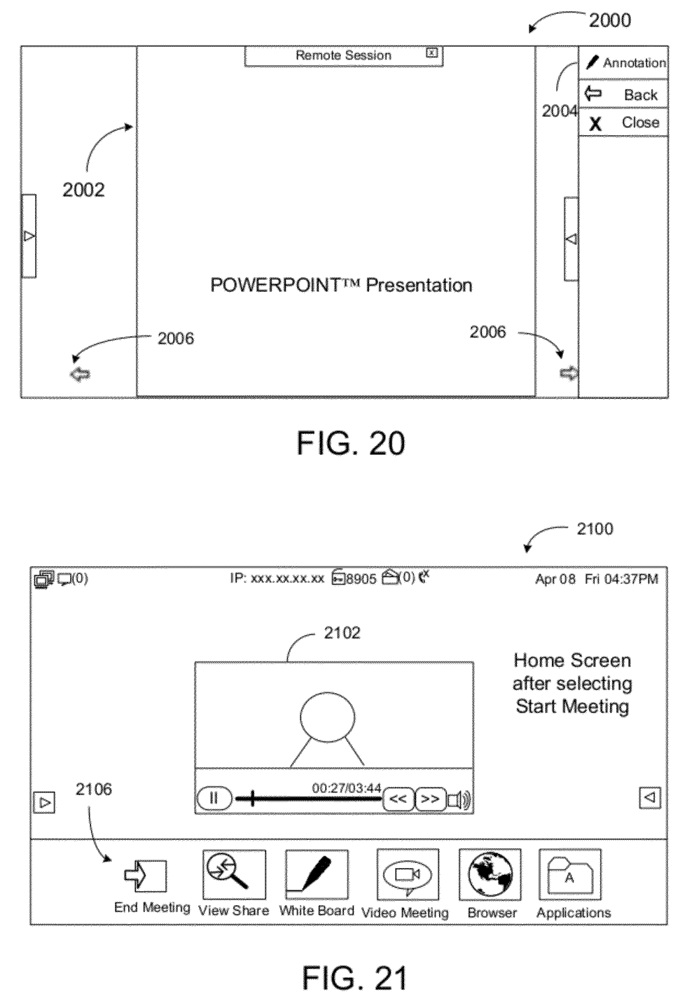

FIGS. 19-20 show example presentation GUIs that may be displayed on the WorkSurface device during an interactive presentation session. It will be appreciated that any suitable presentation format may be employed without departing from the scope of the present disclosure. For example, FIG. 19 shows an example presentation GUI 1900 showing a PDF file 1902. In some example embodiments, the presentation GUI 1900 may place focus on the PDF file being presented by including a limited number of additional windows. For example, in some embodiments, GUI 1900 may include a sidebar 1904 that displays controls relating to the PDF file 1902. In some examples, these controls may include, but are not limited to, a back control to navigate to a previous screen or page and a close control to close or exit the presentation. It should be appreciated that although presentation 1902 is described as a PDF presentation, it may include a POWERPOINT™ presentation or any other suitable presentation. For example, in some embodiments, presentation 1902 may include multiple types of files to be displayed to an audience. In alternative embodiments, presentation 1902 may include a single type of file, such as PPT(X), DOC(X), XLS(X), PDF, FLV, JPEG, BMP, PNG, GIF, TIFF, WMV, MPEG, WMA, MP3, or any other suitable file type.

In some example embodiments, a user may navigate through the presentation by providing input to the WorkSurface device and/or a user computing device. Additionally or alternatively, in some example embodiments, multiple users may be allowed to navigate through the presentation by providing input to WorkSurface devices and/or user computing devices. For example, in some embodiments, a user may navigate through the presentation, the navigation causing any other devices displaying the presentation to navigate through the presentation substantially simultaneously. In alternative embodiments, a user may navigate through the presentation displayed on the user's computing device, but other computing devices displaying the presentation may not be affected. In further alternative embodiments, only one user, such as an administrator, may navigate through the presentation.

FIG. 20 shows an example presentation GUI 2000 showing using a POWERPOINT™ file 2002. It should be appreciated that although presentation 2002 is described as a POWERPOINT™ presentation, it may include a PDF presentation or any other suitable presentation. For example, in some embodiments, presentation 2002 may include multiple types of files to be displayed to an audience. In alternative embodiments, presentation 2002 may include a single type of file, such as PPT(X), DOC(X), XLS(X), PDF, FLV, JPEG, BMP, PNG, GIF, TIFF, WMV, MPEG, WMA, MP3, or any other suitable file type.

As described above, a presentation may be interactively enabled, allowing users to provide annotations to the presentation file either directly (via input detected by the WorkSurface device) or indirectly (via input detected by a local or remote user computing device). Accordingly, in some example embodiments, a sidebar 2004 may be displayed. For example, sidebar 2004 may include an annotation control, a back control, a close control, and/or any other suitable control. In some embodiments, the annotation control may allow one or more users to annotate a presentation. For example, in some embodiments, only an administrative user may annotate the presentation. In alternative embodiments, multiple users may annotate the presentation. For example, in some embodiments, a user may select the annotation control, and provide input to a user computing device in order to alter and/or amend the presentation. Allowing the user to annotate may help the user to illustrate a question, prove a point, and/or otherwise interact with the presentation and collaborate with the audience of the presentation. As discussed above, in some example embodiments, an administrative user may control the users allowed to provide annotation to the presentation. For example, an administrative user may allow a particular number of users to have annotation control. Alternatively or additionally, an administrative user may allow particular users or devices to have annotation control. Further, in some example embodiments, an administrative user may block particular users or devices from having annotation control.

In some example embodiments, a user may navigate through the presentation by providing input to the WorkSurface device and/or a user computing device. For example, a user may select arrows 2006 to navigate to a previous or next page of the presentation 2002. Additionally or alternatively, in some example embodiments, multiple users may be allowed to navigate through the presentation by providing input to WorkSurface devices and/or user computing devices. For example, in some embodiments, a user may navigate through the presentation, the navigation causing any other devices displaying the presentation to navigate through the presentation substantially simultaneously. In alternative embodiments, a user may navigate through the presentation displayed on the user's computing device, but other computing devices displaying the presentation may not be affected. In further alternative embodiments, only one user, such as an administrator, may navigate through the presentation.

FIGS. 21-22 show example collaboration GUIs that may be displayed on the WorkSurface device during a collaboration session, such as a video conference. FIG. 21 shows an example collaboration home screen GUI 2100 that may be displayed after a meeting has started. As shown, a video feed 2102 may be provided in real-time. For example, in some embodiments, video feed 2102 may show a live view of a computing environment of a WorkSurface device or user computing device, as captured by a camera of the WorkSurface device or user computing device. It will be appreciated that more than one video feed may be provided, depending on the number of devices communicatively linked to the WorkSurface device. Further, a user may customize a view of the one or more video feeds in virtually any conceivable manner, including but not limited to, hiding a video feed, enlarging a video feed, and/or rearranging one or more video feeds such that a video feed or feeds is displayed in a user-defined configuration on each WorkSurface device and/or user computing device. In some embodiments, the user-defined configuration may vary between each device; however it should be appreciated that in alternative embodiments, one user-defined configuration may be displayed on all devices. In some example embodiments, controls 2106 may include an End Meeting icon in the place of the Start Meeting icon described above with respect to FIG. 11. For example, a user may select a Start Meeting icon on controls 1106, and in response, controls 2106 may be displayed, including an End Meeting icon.

FIG. 22 shows another example collaboration GUI 2200 that may be displayed during a video conference. For example, a video conference may provide a video feed 2202 of a user in a remote location and video conference controls 2204, which may include a dial pad for entering a phone number, access code, email address, and/or other identifying information used to contact a person or device. Video conference controls 2204 may also include but are not limited to a contact list, a list of recent calls, a settings window, and/or a messages window. Video conference controls 2204 may therefore be used in some embodiments to establish and/or conduct a video conference, phone call, and/or other suitable communication between users and/or devices. Furthermore, various controls may appear as tabbed windows, allowing a user to view and select tabs in order to expand particular controls corresponding to a selected tab. For example, in some embodiments, a user may select a settings tab of video conference controls 2204 in order to customize and/or set settings for a video conference. Further, in some example embodiments, a user may select a messages tab of video conference controls 2204 in order to view messages including but not limited to video, voice, email, and/or text messages. In some example embodiments, a user may select a contacts tab in order to view, edit, remove, add, and/or search contacts. In further example embodiments, a user may select a history tab in order to view, edit, remove, and/or search a history of calls. For example, a user may select a history tab in order to view the last call in order to quickly reconnect with the associated device and/or user.

GUI 2200 may also include in some embodiments additional controls 2206. Controls 2206 may include, but are not limited to, a Network control, a Service control, a Self View Control, and a Help control. For example, a user may select a Network control in order to view information relating to network connections of the WorkSurface device and/or user computing device. Additionally or alternatively, the user may select the Network control in order to establish and/or alter settings related to a network connection. In further example embodiments, a user may select a Service control in order to view running services, view and/or select available elements to facilitate communication between multiple users, and/or access any other suitable service control.

In still further example embodiments, a user may select a Self View control in order to display a video or image of the user on GUI 2200. For example, an additional window may be displayed on GUI 2200 showing a video or image captured from a camera of the user's computing device. In alternative embodiments, video feed 2202 may display a video or image captured from a camera of the user's computing device instead of a video or image captured from another computing device. Furthermore, in some example embodiments, a user may select a Help control in order to view a help file, connect to a help webpage, contact a support provider, and/or access any suitable help element in order to aid a user.

FIGS. 23-25 show example interactive GUIs that may be displayed on the WorkSurface device during an interactive presentation session and/or during a collaboration session. FIG. 23 shows an example view and share GUI 2300. Such a View and Share screen may be available to any user, as opposed to the example View and Share screen for administrative management discussed above with reference to FIG. 7. View and Share window 2302 may enable a presenter to select various elements 2304, which may include files, applications, programs etc., to begin a WorkSurface session. For example, elements 2304 may include a contact folder, including contact information for an individual, various folders including one or more files, and/or individual files, including PPT(X), DOC(X), XLS(X), PDF, FLV, JPEG, BMP, PNG, GIF, TIFF, WMV, MPEG, WMA, MP3, or any other suitable file type.

In some example embodiments, GUI 2300 may include a sidebar 2306, including various controls for the View and Share window 2302. For example, sidebar 2306 may include a List control, a Refresh control, a Sort control, a Recycle Bin control, a Help control, a USB ID control, and/or any other suitable control for View and Share window 2302. In one example embodiment, a user may select the List control in order to change the view of View and Share window 2302. For example, upon selecting the List control, the View and Share window 2302 may be altered from showing an icon view to a list view. In an alternative or additional example embodiment, a user may select a Refresh control in order to update the View and Share window 2302 to display a current listing of files.

In another alternative or additional example embodiment, a user may select a Recycle Bin control in order to view recycled files from the View and Share window 2302. In yet another alternative or additional example embodiment, a user may select a Help control in order to view a help file, connect to a help webpage, contact a support provider, and/or access any suitable help element in order to aid a user. In still another alternative or additional example embodiment, a user may select a USB ID control in order to view attached USB devices, and/or perform any other suitable control relating to USB devices. For example, a user may select a USB ID control in order to view files located on a USB drive attached to the user's computing device.

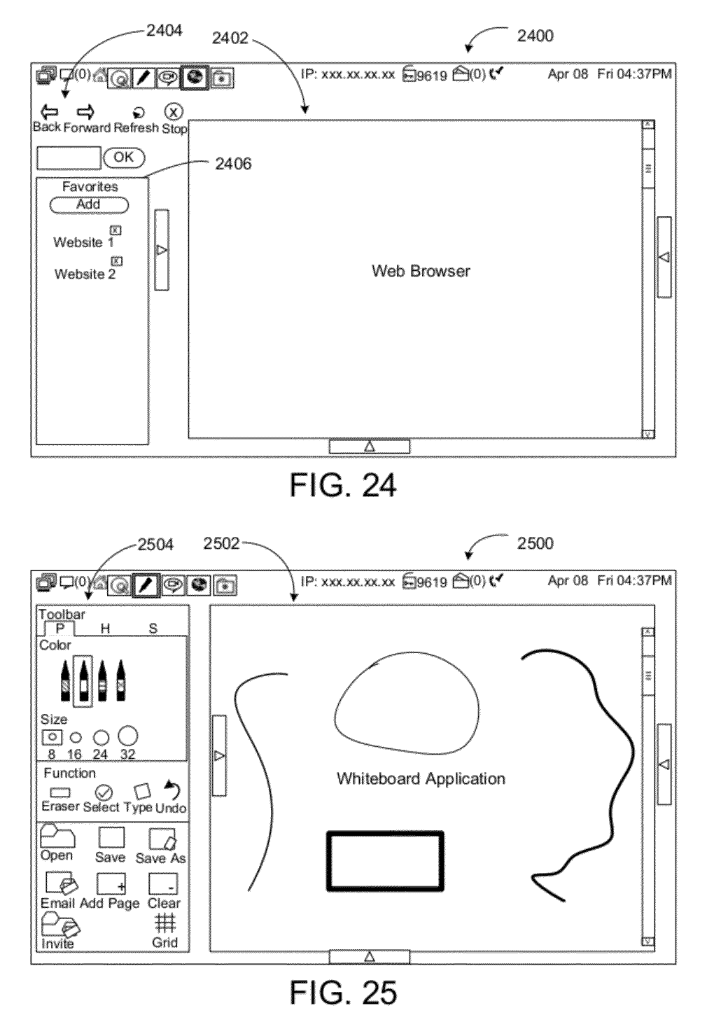

FIG. 24 shows an example internet browser GUI 2400 that may be available on the WorkSurface device. In an example embodiment, Internet browser GUI 2400 may include an internet browser window 2402 that allows a user to browse the internet directly from and/or through a WorkSurface device. In some embodiments, Internet browser 2402 may be a browser configured for a particular operating system, such as a WINDOWS™ operating system, in order to provide familiar controls and a familiar appearance to users accustomed to such browsers and/or operating systems. In alternative example embodiments, Internet browser 2402 may be configured for the WorkSurface device, a mobile device, etc., in order to optimize functionality for capabilities of a particular device.

In some example embodiments, GUI 2400 may include controls 2404. For example, controls 2404 may include back and forward controls for navigating to a previously or subsequently visited web page, refresh control for refreshing a web page, stop control for ceasing loading of a web page, and/or any other suitable internet-related control. In additional or alternative example embodiments, GUI 2400 may include a favorites sidebar 2406. For example, favorites sidebar 2406 may include a list of favorite web pages. In some embodiments, a user may add a web page to the favorites list by clicking an add button. For example, clicking an add button may add a web page that the user is currently viewing to the list. Alternatively, clicking an add button may cause a new screen to be displayed, prompting the user for information pertaining to a web page that may be added to the list. In some embodiments, a user may delete an unwanted web page from a favorites list by selecting a delete icon proximate to a description or representation of the unwanted web page. It should be appreciated that controls 2404 and/or sidebar 2406 may be included in any of the previously described GUIs. Alternatively, it should be appreciated that in some embodiments, controls 2404 and/or 2406 may only be included in some or none of the previously described GUIs.

FIG. 25 shows an example interactive whiteboard GUI 2500 that may be associated with an interactive whiteboard application 2502. As shown, the interactive whiteboard application 2502 may include various controls 2504 that may be selected to provide annotative input (e.g., drawing, highlighting, painting, formatting, etc.). As described above, controls 2504 may be available on other computing devices such that a user may provide annotative input via their personal computing device and have that annotation appear on the display of the WorkSurface device when a communicative link is established between the devices.

In some example embodiments, controls 2504 may include selectable input features, such as input type, color, size, etc. Such controls may aid in distinguishing one user's annotation from another user's annotation, and may facilitate the illustration of a user's idea, question, etc. In additional or alternative embodiments, controls 2504 may include functions such as an eraser, select, type, undo, etc. In further additional or alternative embodiments, controls 2504 may include application controls, such as open, save, save as, email, add page, clear, invite, grid, etc. Accordingly, in some example embodiments, a user may open a previously created whiteboard page, save a current whiteboard page, save a current whiteboard page as a particular file name, email a whiteboard page, add a new whiteboard page, clear a current whiteboard page, invite a user to a current whiteboard session, display a grid on a whiteboard page to facilitate illustrations, etc.

It will be appreciated that the example GUIs shown in FIGS. 6-25 may contain various icons, controls, elements, and/or other features that may allow an administrator and/or another user to navigate, control aspects, provide input, etc. in association with the various GUIs of the WorkSurface device. While each GUI may show a particular icon, control, element and/or other feature in a particular location on the display, it will be appreciated that icons, controls, elements, and features may be located in virtually any location and in virtually any combination without departing from the scope of the present disclosure. Further, in some embodiments, the icons, controls, elements, and features may have a visual representation other than the examples shown in FIGS. 6-25.

One or more customizable GUIs may have a format corresponding to a type of device displaying the customizable GUI. Some embodiments may facilitate this customization by having a customizable GUI in a mobile format for mobile devices and/or devices with a display screen having a diagonal length smaller than or equal to a first value, such as 3.5 inches, 4.5 inches, or any other suitable value. For example, a mobile format may provide fewer windows and more selectable icons in order to compensate for a small screen size. In alternative or additional embodiments, a customizable GUI may also have a tablet format for tablet device and/or devices with a display screen having a diagonal length greater than the first value and smaller than or equal to a second value, such as 8 inches, 10 inches, or any other suitable value. In further alternative or additional embodiments, a customizable GUI may have a standard format for desktop computers, laptop computers, WorkSurface devices, and/or devices having a diagonal length greater than the first and second values. In some example embodiments, the format of a customizable GUI may provide a resolution for the GUI, a set of rules for customization of the GUI, and/or any other setting that affects the appearance of the GUI in order to optimize the GUI for a particular device or type of device, thereby enhancing a user experience with the GUI.

Therefore, as described, in some embodiments, an interactive and collaborative computing device may include an interaction module including a first display integral to the interactive and collaborative computing device and an input sensor. In some embodiments, the interactive and collaborative computing device may also include a collaboration module including a first camera, a networking module including a network interface, a control module, and a mass storage unit integral to the interactive and collaborative computing device and communicatively coupled to the collaboration module, the networking module, and the remote control module. For example, the mass storage unit may hold instructions executable by a processor of the interactive and collaborative computing device to present a multimedia presentation to an audience via the first display, establish a communicative link with a first source device via the network interface, receive input from the first source device at the control module, and upon receiving the input at the control module, alter the multimedia presentation on the first display of the interactive and collaborative computing device in accordance with the input.

In some embodiments, the interactive and collaborative computing device may include a large form display device having a diagonal length greater than or equal to 50 inches. Additionally or alternatively, the interactive and collaborative computing device may include an input sensor that detects a touch input directed toward the display of the interactive and collaborative computing device, the input sensor may be operable to detect and process one or more of optical, resistive, and capacitive touch input. Furthermore, in additional or alternative embodiments, the input sensor may be operable to detect and process multiple concurrent touch inputs.

In some embodiments, the interactive and collaborative computing device may include a camera that captures a first visual of a computing environment of the interactive and collaborative computing device for a first video feed, the first video feed being displayed on the first display. Further, in some embodiments, a source device may include a second camera configured to capture a second visual for a second video feed of a computing environment of the first source device, and the source device may send the second video feed to the interactive and collaborative computing device. Additionally or alternatively, a presentation on an interactive and collaborative computing device may include an interactive whiteboard application that allows multi-user collaboration via one or more source devices communicatively linked with the interactive and collaborative computing device.

In further embodiments, a method for establishing a communicative link with an interactive and collaborative computing device including a first display and a touch input sensor may include establishing a communicative link between the interactive and collaborative computing device and a first source device including a second display and presenting a presentation to the first display and the second display. Further, in some embodiments, upon establishing the communicative link, the method may include detecting input by a sensor of the first source device to alter the presentation, sending the input to the interactive and collaborative device, controlling via a control module an alteration of the presentation based on the detected input, and displaying, on the first display and the second display, the alteration of the presentation.

In some embodiments, the method may further include establishing a phone call between the interactive and collaborative computing device and the first source device. In additional or alternative embodiments, the method may include displaying a customizable graphical user interface (GUI) on each of the first display and the second display, and the customizable GUI may have a format corresponding to a type of device displaying the customizable GUI. Additionally or alternatively, in some embodiments, the customizable GUI may be configured to display instructions for connecting the first source device to the interactive and collaborative computing device. In some embodiments, the method may include allowing an administrative user to gain access to administrative controls by completing an administrative login procedure on an administrative user device. For example, in some embodiments, the administrative controls may include one or more of device access controls, user access controls, presentation controls, and user contact list controls.

In some embodiments, the method may include displaying a list of files that are accessible to the interactive and collaborative computing device and the first source device during a presentation of the interactive and collaborative computing device, the list of files being limited to include only file types approved by the administrative user. Further, in some embodiments, the administrative user device may be the first source device and the administrative user may provide input to the interactive and collaborative computing device via the first source device. In alternative embodiments, the administrative user device may be the interactive and collaborative computing device and the administrative user may provide input to the interactive and collaborative computing device via at least one of touch input directed to the first display and one or more peripheral input devices communicatively coupled to the interactive and collaborative computing device.

In still further embodiments, a system for an interactive and collaborative environment may include a first interactive and collaborative computing device having an integrated first display, including an interaction module, a collaboration module, a networking module, a control module, and a mass storage unit integral to the first interactive and collaborative computing device. In some embodiments, the system may include a first source device communicatively linked to the first interactive and collaborative computing device via a network, wherein content viewed on the first display of the first interactive and collaborative computing device is annotated via user input detected by the first source device, and wherein annotated content is implemented by the control module in real-time and provided on the first display of the first interactive and collaborative computing device and provided on a second display of the first source device.

In some embodiments, the system may include a video feed of a computing environment of the first source device and a second source device that may be displayed in a user-defined configuration on each of the first interactive and collaborative computing device and the first and second source devices. Additionally or alternatively, the system may allow two concurrent user inputs associated with two source devices to be concurrently displayed on each of the first interactive and collaborative computing device and the first and second source devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An interactive and collaborative computing device, the device comprising:
an interaction module including a first display integral to the interactive and collaborative computing device and an input sensor;
a collaboration module including a first camera;
a networking module including a network interface;
a control module; and
a mass storage unit integral to the interactive and collaborative computing device and communicatively coupled to the collaboration module, the networking module, and the remote control module, the mass storage unit holding instructions executable by a processor of the interactive and collaborative computing device to:
present a multimedia presentation to an audience via the first display;
establish a communicative link with a first source device via the network interface;
receive input from the first source device at the control module;
upon receiving the input at the control module, alter the multimedia presentation on the first display of the interactive and collaborative computing device in accordance with the input.

2. The interactive and collaborative computing device of claim 1, wherein the display is a large form display device having a diagonal length greater than or equal to 50 inches.

3. The interactive and collaborative computing device of claim 1, wherein the input sensor detects a touch input directed toward the first display, the input sensor operable to detect and process one or more of optical, resistive, and capacitive touch input.

4. The interactive and collaborative computing device of claim 3, wherein the input sensor is operable to detect and process multiple concurrent touch inputs.

5. The interactive and collaborative computing device of claim 1, further comprising a universal serial bus (USB) port integral to the first display, the USB port configured to allow communicative coupling between the interactive and collaborative computing device and at least one of the first source device and an external storage device.

6. The interactive and collaborative computing device of claim 1, wherein the first camera captures a first visual of a computing environment of the interactive and collaborative computing device for a first video feed, the first video feed being displayed on the first display.

7. The interactive and collaborative computing device of claim 6, wherein the first source device comprises a second camera configured to capture a second visual for a second video feed of a computing environment of the first source device, the first source device sending the second video feed to the interactive and collaborative computing device.

8. The interactive and collaborative computing device of claim 1, wherein the presentation includes an interactive whiteboard application that allows multi-user collaboration via one or more source devices communicatively linked with the interactive and collaborative computing device.

9. A method for establishing a communicative link with an interactive and collaborative computing device including a first display and a touch input sensor, the method comprising:
establishing a communicative link between the interactive and collaborative computing device and a first source device including a second display;
presenting a presentation to the first display and the second display;
wherein upon establishing the communicative link, detecting input by a sensor of the first source device to alter the presentation, sending the input to the interactive and collaborative device, controlling via a control module an alteration of the presentation based on the detected input, and displaying, on the first display and the second display, the alteration of the presentation.

10. The method of claim 9, further comprising displaying a customizable graphical user interface (GUI) on each of the first display and the second display, the customizable GUI having a format corresponding to a type of device displaying the customizable GUI.

11. The method of claim 10, wherein the customizable GUI is configured to display instructions for connecting the first source device to the interactive and collaborative computing device.

12. The method of claim 10, further comprising, allowing an administrative user to gain access to administrative controls by completing an administrative login procedure on an administrative user device.

13. The method of claim 12, wherein the administrative controls include one or more of device access controls, user access controls, presentation controls, and user contact list controls.

14. The method of claim 13, further comprising displaying a list of files that are accessible to the interactive and collaborative computing device and the first source device during a presentation of the interactive and collaborative computing device, the list of files being limited to include only file types approved by the administrative user.

15. The method of claim 12, wherein the administrative user device is the first source device and the administrative user provides input to the interactive and collaborative computing device via the first source device.

16. The method of claim 12, wherein the administrative user device is the interactive and collaborative computing device and the administrative user provides input to the interactive and collaborative computing device via at least one of touch input directed to the first display and one or more peripheral input devices communicatively coupled to the interactive and collaborative computing device.

17. The method of claim 9, further comprising establishing a phone call between the interactive and collaborative computing device and the first source device.

18. A system for an interactive and collaborative environment, the system comprising:
a first interactive and collaborative computing device having an integrated first display and including an interaction module, a collaboration module, a networking module, a control module, and a mass storage unit integral to the first interactive and collaborative computing device; and
a first source device communicatively linked to the first interactive and collaborative computing device via a network;
wherein content viewed on the first display of the first interactive and collaborative computing device is annotated via user input detected by the first source device; and
wherein annotated content is implemented by the control module in real-time and provided on the first display of the first interactive and collaborative computing device and provided on a second display of the first source device.

19. The system of claim 18, wherein a video feed of a computing environment of the first source device and a second source device is displayed in a user-defined configuration on each of the first interactive and collaborative computing device and the first and second source devices.

20. The system of claim 19, wherein two concurrent user inputs associated with two source devices are concurrently displayed on each of the first interactive and collaborative computing device and the first and second source devices.
